(19) United States
(12) Patent Application Publication
(10) Pub. No.: US 2026/0349824 A1
(43) Pub. Date: Nov. 5, 2026

(54) CROSS-SITE ROUTING OF INFERENCE WORKLOADS BASED ON PREDICTED POWER AVAILABILITY

(71) Applicant: MICROSOFT TECHNOLOGY LICENSING, LLC, Redmond, WA (US)

(72) Inventors: Srinivasan IYENGAR, Bangalore (IN); Chaojie ZHANG, Redmond, WA (US); Shivkumar KALYANARAMAN, Bangalore (IN); Rohan GANDHI, Pune (IN); Debopam BHATTACHERJEE, Bengaluru (IN); Anjaly PARAYIL, Bengaluru (IN); . PALAK, Hisar (IN); Jayashree MOHAN, Bangalore (IN); Liangcheng YU, Redmond, WA (US); Tella Rajashekhar REDDY, Hyderabad (IN)

(21) Appl. No.: 19/191,554

(22) Filed: Apr. 28, 2025

(51) Int. Cl. G06F 9/50

(52) U.S. Cl. CPC G06F 9/505; G06F 9/5094; G06F 2209/503

(57) ABSTRACT

The disclosure presents a technique for routing discrete AI inference workloads to processor clusters co-located with distinct variable-power sources. This technique includes a workload routing process implemented by a cross-site router with four main components: a long-term planner, a short-term planner, a configurator, and a request scheduler. The long-term planner uses workload arrival patterns and long-term predicted power availability at processing sites to generate a first allocation plan for configuring processor frequency and tensor parallelism, and routing inference workloads. The short-term planner uses the first allocation plan and short-term predicted power availability at processing sites to generate a second allocation plan for adjusting processor frequency and routing inference workloads. The configurator allocates processors at the processor clusters based on the first allocation plan and the second allocation plan. The request scheduler routes workload requests to the processing sites based on workload characteristics and the second allocation plan.

### BACKGROUND

The rapid acceleration of artificial intelligence (“AI”) adoption has significantly increased demand for power-intensive computational workloads to perform the compute necessary to implement AI. The power needs for AI will soon overtake those associated with traditional enterprise or web services. These workloads, driven in large part by large-scale inference tasks, are being generated broadly from many sources including industries, governments, and consumer applications. As demand for AI capabilities increases, so too does the need for continuous access to high-performance compute infrastructure. Over time, this need may result in a sustained pressure on existing power grids.

Inference workloads—which include real-time processing of natural language prompts, chat queries, content generation tasks, and other user-facing AI interactions—are often numerous, discrete, and latency-sensitive. These workloads are typically backed by large models running on accelerator hardware and require rapid response times to maintain user experience expectations. Because such queries may arrive unpredictably and in high volume, these models must remain active and scalable, leading to sustained and often spiky power consumption. As a result, availability of power has become a critical constraint on access to AI, especially in regions where available electrical capacity is limited or already oversubscribed.

Historically, the design and placement of data centers for processing AI and other compute tasks have been optimized primarily for performance objectives, such as minimizing user-perceived latency, reducing network round-trip times, and improving service responsiveness. While power availability has always been a consideration in data center infrastructure planning, a prevailing assumption in that planning was power grids would be capable of scaling to meet the needs of expanding compute demand. However, as the power demand of AI compute workloads continues to grow, the assumption that power availability can and will naturally scale to match compute deployment has become harder to sustain in the face of ailing power grids that are increasingly strained.

Specifically, power grids are struggling to keep up with the demands of AI compute because expanding power infrastructure (transmission lines, distribution, and storage) is costly, legally & logistically complex, and requires government approvals. Furthermore, even after grid approvals and commissioning, power sources face significant curtailment due to grid congestion, which prevents large portions of generated power from being utilized. Additionally, the long-distance transmission and distribution of power results in significant power loss, substantially inflating the cost of bringing far-away power to areas of high demand. As a result, aging grids nearing the end of their lifespan, pushed by higher demand, may adopt strategies affecting the energy mix and, hence, the sustainability goals of power grid stakeholders. Accordingly, it would be desirable to identify complimentary architectures that work with existing power infrastructure to provide additional power to computing devices that process AI inference workloads. This disclosure is made with respect to these and other considerations.

### SUMMARY

This disclosure provides a technique for powering AI, and other computing workloads, by locating processing power near variable-power sources, such as wind turbines or solar farms. This brings the energy-consuming processing components (e.g., graphics processing units (“GPUs”), central processing units (“CPUs”), tensor processing units (“TPUs”), neural processing units (“NPUs”), application-specific integrated circuits (“ASICs”), or other processors suited to running inference models close to variable-power sources, which eliminates the need for the costly and inefficient transmission of power over long distances. However, a limitation with variable-power sources, unlike standard grid power, is that power levels may not always be sufficient to support processing components. As the name suggests, the amount of power available from variable-power sources can fluctuate with changes related to environmental factors, such as wind speed in the case of wind power or solar irradiance in the case of solar power. Thus, two challenges exist in using variable power to process AI inference workloads: 1) right-sizing the deployment configuration of processors across multiple processing sites, i.e., determining how many processors should be used at each site and at what frequency those processors should run, given variable power availability, and 2) determining how best to route workloads comprising inference requests across those same processing sites, each supplied by separate variable-power sources, to right-size the load on the processors given variable power availability.

To address these challenges, the system disclosed herein includes a router that receives discrete AI inference workloads and routes them across multiple processing sites based on workload characteristics and site-wise predicted power availability. Specifically, the router begins by using long-term insights and predictions to configure processor instances at the processing sites. Processors are part of physical processor clusters co-located with variable power sources at processing sites, and individual processors in one or more processor clusters may be configured to work together on one or more inference workloads as a processor instance (“instance”).

Processor configuration is initially handled by a long-term planner (“Planner-L”) within the router that looks at long-term trends in power availability across processing sites and workload arrival patterns. Workload arrival patterns are comprised of historic trends in the volume of inference workloads received by the router and historic trends in the characteristics of the workloads received by the router. Workload characteristics, such as the length of a user's input query and the length of an AI inference model's corresponding output response, can meaningfully impact the amount of power consumed and/or latency incurred in processing a workload, making workload characteristics an important component of right-sizing processor deployment and workload routing. Workload characteristics can also be used to assign a “class” to each workload (described in more detail below), which can then be used to facilitate routing the workload to the appropriate processing site and processor instance that is configured to handle that class of workload.

The long-term planner uses long-term trends in power availability and workload arrival patterns to determine the number of processor instances in the system that will be available over a first, long-term timescale to accommodate the peak load of each class of workload at each processing site. The long-term planner also uses a reconfiguration threshold to limit the number of configuration changes that are allowed for each processor instance over the first, longer timescale. This is to make sure that processor instance reconfigurations do not add significant overhead to each cycle of the first, long-term timescale.

Within the bounds of the reconfiguration threshold, the long-term planner assigns configurations to one or more processor instances for handling one or more specific classes of workload at each site. For example, the long-term planner uses the long-term trends in power availability and the workload arrival patterns to determine a tensor parallelism (“TP”) metric for each processor instance that specifies how many processors will work together while processing one or more workloads in a specific class of workload. A processor instance that handles a class of workload requiring relatively little power, such as a short input, short output (“short:short”) workload, may have a TP metric of 2. A TP metric of 2 indicates two processors are allocated to that processor instance. Conversely, a processor instance configured to handle a more power-intensive class of workload, such as a long input, long output (“long:long”) workload, may have a TP metric of 8, indicating eight processors are allocated to that processor instance to handle those workloads.

The long-term planner also uses the long-term trends in power availability and the workload arrival patterns to determine a first frequency metric, a first load metric, and a distribution metric for configuring one or more processor instances. The first frequency metric specifies a maximum clock speed at which allocated processors in a processor instance can operate, e.g., 2.0 GHz. The first load metric specifies the number of workloads per second that will be routed to each processor instance. The distribution metric specifies the fraction of total inference workloads per class that will be routed to individual processor instances across multiple processing sites in the system. The long-term planner outputs these metrics as a first allocation plan that is received by a configurator and a short-term planner (“Planner-S”) in the router.

The configurator is responsible for distributing the metrics of the first allocation plan to site-wise schedulers and configurators. In response to receiving an output from the configurator, the site-wise schedulers and configurators then implement configurations for individual processors and processor instances at the processing sites in the system based on the output. Additionally, as will be discussed in more detail below, the configurator acts to restrain the short-term planner from performing reconfiguration operations on any processors or processing instances that are pending (re)configuration based on the first allocation plan.

The short-term planner operates on a second, short-term timescale relative to the first, long-term timescale of the long-term planner, e.g., seconds instead of minutes. The short-term planner is responsible for adjusting processor frequencies and the number of workloads per second that will be routed to each processor instance. The short-term planner makes these adjustments based on the first allocation plan output by the long-term planner and the predicted power availability at processing sites over the second, shorter timescale.

The long-term planner operates on a longer timescale relative to the short-term planner because certain aspects of configuring processor instances are only practical over the first, long-term timescale of the long-term planner—aspects such as determining a TP metric and having the configurator send out configuration data to adjust processors at processing sites accordingly. However, having the long-term planner manage these configuration tasks forces the long-term planner to operate on a timescale that sacrifices some efficiency in terms of predicting site-wise power availability and workload arrival patterns. The shorter timescale of the short-term planner allows the short-term planner to predict power availability at processing sites and workload volume with increased granularity, which the short-term planner can use to update processor frequencies and the number of workloads per second routed to each processor instance in near real-time.

Specifically, the short-term planner uses the first allocation plan and short-term power predictions from processing sites to generate a second allocation plan comprising a second frequency metric and a second load metric. The second frequency metric specifies an update to the maximum clock speed at which allocated processors in a processor instance can operate, e.g., increasing from 2.0 GHz as specified by the first frequency metric to 2.2 GHz. The second load metric specifies an update to the number of workloads per second that will be routed to each processor instance.

The short-term planner outputs these metrics as part of the second allocation plan, which is then received by the configurator and a workload scheduler. As with the first allocation plan, the configurator distributes the metrics of the second allocation plan to site-wise schedulers and configurators that adjust the configuration of one or more processors and one or more processor instances at one or more processing sites based on the metrics of the second allocation plan.

The workload scheduler is responsible for dispatching workloads across the processing sites in the system as the requests arrive in an arrival queue. The workload scheduler uses the second allocation plan of the short-term planner to determine weights that it utilizes with a scheduling algorithm, such as a weighted round robin, to route workloads from each workload class to processor instances across the processing sites in the system. In some embodiments, the workload scheduler also includes a packing heuristic that allows workloads to be reallocated to different workload classes based on real-time loads and available compute. For example, if the workload scheduler observes that a processing instance has received a lower number of workloads in a given class (e.g., long-medium) than expected, the workload scheduler can move a fraction of workloads from another class (e.g., long-short) to the class with the lower-than-expected number of workloads for processing. This allows the system maximize the use of available compute resources and increase the overall performance of the system.

In some embodiments, the packing heuristic is configured so the workload scheduler starts with larger workloads, reassigns them according to the specified fractional limit, and progressively moves to smaller workloads to free up compute resources at each step. In other embodiments, the packing heuristic may be configured to reallocate workloads in other quantities (e.g., a raw number of workloads from a given class) and/or in other orders (e.g., starting with smaller workloads and moving to larger workloads) based on the needs of system operators and/or the system itself.

The workload scheduler also comprises a workload class predictor that analyzes one or more inference requests of a workload, i.e., one or more user input queries, as well as one or more corresponding inference models being run on processor instances in the system, and predicts the output length to determine the characteristics and corresponding class of the workload. The workload scheduler then uses the workload characteristics, the second allocation plan, and the scheduling algorithm to route the workload to a processor instance that is both configured to process the class of workload corresponding to the workload's characteristics and that operates at a processing site with enough predicted power and compute resource over the second, short-term timescale to accommodate the workload.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a system diagram showing an overview of a system for powering AI, and other computing workloads, by co-locating processor clusters with variable-power sources at processing sites.

FIG. 2 is a system diagram showing the system in a state where a long-term planner in a cross-site router is receiving workload arrival patterns and long-term power predictions from processing sites in the system and using them to generate a first allocation plan for routing AI inference workloads to processor clusters comprising processor instances.

FIG. 3 is a system diagram showing the system in a state where the first allocation plan generated by the long-term planner is being received by a short-term planner, a configurator, and a workload scheduler.

FIG. 4 is a system diagram showing the system in a state where a configurator is receiving the first allocation plan and sending a first set of configuration data based on the first allocation plan to processors at processing sites comprising processor clusters co-located with distinct variable-power sources.

FIG. 5 is a system diagram showing details of a processing site comprising processor clusters co-located with at least one distinct variable-power source, wherein at least one processor and at least one processor instance are being configured by a first set of configuration data received from the configurator.

FIG. 6 is a system diagram showing the system in a state where the short-term planner is receiving short-term power predictions from the processing sites comprising processor clusters co-located with distinct variable-power sources and the first allocation plan generated by the long-term planner to generate a second allocation plan.

FIG. 7 is a system diagram showing the system in a state where the configurator is receiving the second allocation plan and sending a second set of configuration data based on the second allocation plan to processors at processing sites comprising processor clusters co-located with distinct variable-power sources.

FIG. 8 is a system diagram showing details of a processing site comprising processor clusters co-located with at least one distinct variable-power source, wherein at least one processor is being configured by the second set of configuration data received from the configurator.

FIG. 9 is a system diagram showing the system in a state where the workload scheduler is receiving a workload, and a workload class predictor is determining workload characteristics for the workload.

FIG. 10 is a system diagram showing the system in a state where the workload scheduler is routing the workload to one of the processing sites comprising processor clusters co-located with at least one distinct variable-power source based on the workload characteristics of the workload and the second allocation plan.

FIG. 11 is a system diagram showing details of a processing site comprising processor clusters co-located with at least one distinct variable-power source. The processing site is receiving a workload, and a site-wise scheduler and configurator is routing the workload to a processor cluster comprising a processor instance that is configured to handle the class of workload corresponding to the workload's characteristics.

FIG. 12 is a chart showing how power complementarity across variable power sites can be utilized to minimize dropped inference requests.

FIGS. 13A and 13B are flow diagrams showing an illustrative process for routing discrete inference workloads to processor clusters co-located with distinct variable-power sources.

FIG. 14 is a computer architecture diagram showing an illustrative computer hardware and software architecture for a computing system capable of implementing aspects of the techniques and technologies presented herein.

### DETAILED DESCRIPTION

An inference model is a trained machine learning model used to make predictions or decisions based on new, unseen data. It applies patterns and relationships learned during the model's training to generate outputs, and each time the model is asked to provide a result, such as identifying objects in images, detecting anomalies in data, or answering questions, it processes an inference request. Large Language Models (“LLMs”) are an increasingly common example of inference models, as they use their extensive training on data sets to generate human-like language responses based on input from users.

To generate these responses, inference models typically rely on specialized processor hardware to perform complex mathematical operations required to generate the model's predictive outputs. When an inference request is made, the model processes the input data by performing numerous matrix multiplications, vector operations, and activation functions. Because these calculations involve a high degree of parallelism, they benefit from processors designed to handle large-scale computations efficiently. The speed and accuracy of the model's predictions depend heavily on the underlying hardware's ability to manage these operations effectively.

As a result of this dependency, certain types of processors are particularly well-suited for handling inference requests due to their ability to perform large-scale parallel computations. Graphics processing units (“GPUs”) are often used because they contain thousands of cores optimized for matrix operations, which are a key component of neural network calculations. Additionally, specialized processors like tensor processing units (“TPUs”) and neural processing units (“NPUs”) are designed specifically for AI workloads and provide even greater efficiency. By grouping multiple GPUs, TPUs, or NPUs together in a single instance—a configuration of processing units working together to handle one or more inference workloads—organizations can process large volumes of inference requests more quickly and efficiently. However, as more processors are devoted to inference workloads, the system's overall power demand increases. Each processor performing intensive computations requires additional electricity, leading to higher energy consumption as the scale of the processing infrastructure grows in either size, sophistication, or both.

Historically, the infrastructure supporting inference workloads has been built around traditional power grids, which are typically designed to provide a stable and continuous supply of electricity. These systems assume a virtually unlimited power supply, enabling organizations to scale their inference operations without significant concern for energy constraints. As AI applications have expanded in scope and complexity, this reliance on traditional power grids has continued, with large-scale data centers and compute clusters drawing increasing amounts of electricity to meet the growing demand for inference processing.

However, these assumptions for supplying power are becoming increasingly outdated as power grids face rising demand from multiple sources. With inference models requiring ever more computational power, grid operators might struggle to balance power supply and demand. The constant expansion of AI infrastructure contributes to peak load pressures, resulting in higher operational costs and the risk of outages. These challenges are now limiting the growth of inference processing operations, particularly in regions where power capacity is constrained or heavily regulated.

While inference workloads often require consistent, low-latency processing to maintain real-time responses, their nature as distinct and independent tasks makes them uniquely adaptable to variable power environments. Unlike continuous processes that rely on a constant flow of power, inference requests can be completed quickly and individually. This allows them to be dynamically routed across multiple processors in different locations, shifting tasks away from sites experiencing power drops. Intelligent workload management systems and real-time monitoring further enhance this flexibility, ensuring that inference operations remain responsive even when relying on variable power sources. This capability positions inference workloads as a viable candidate for sustainable computing solutions that reduce dependence on traditional power grids.

This disclosure provides a solution that allowed discrete AI inferencing workloads to be routed to processing sites comprising processing components co-located with distinct variable-power sources (“variable-power sources” or “power sources”), thereby alleviating the constraints posed by current power supply infrastructure. Additionally, the techniques disclosed herein incorporate predicted power availability from these sites, allowing workloads to be dynamically rerouted around site-specific power reductions. This unlocks additional power supply for supporting AI inference workloads while still minimizing the number of dropped requests and the latency experienced by users.

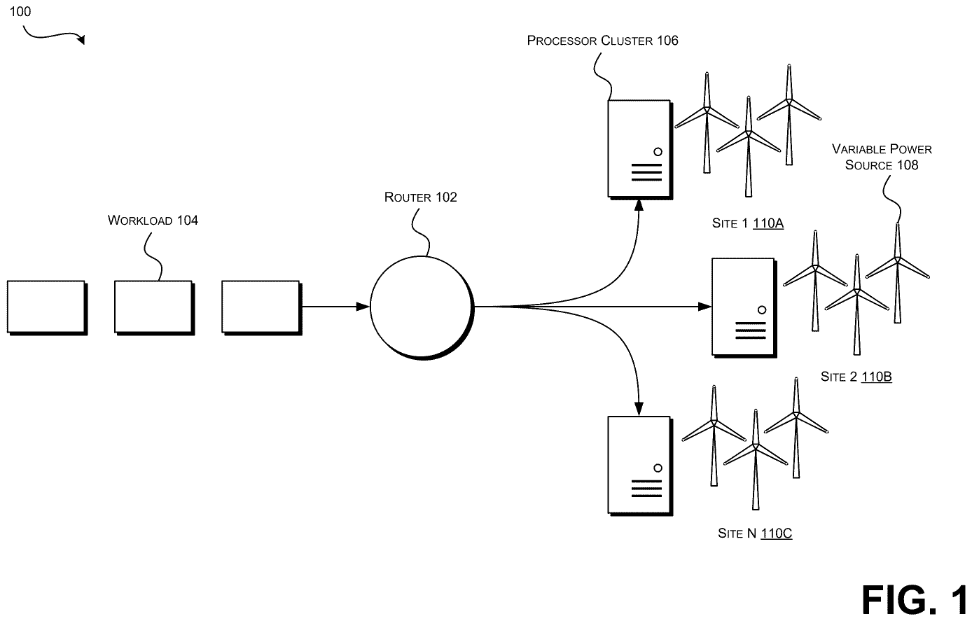

FIG. 1 illustrates an overview of a system 100 for routing discrete workloads (“workloads”) 104 to processing sites 110 that each comprise at least one processor cluster 106 and at least one variable power source 108. A workload is a self-contained computational task, or set of tasks, that can be processed independently within the system 100, and each workload 104 consists of at least one AI inference request. An inference request comprises applying a trained inference model to input data provided by a user to generate a prediction or response from the model.

The workloads are received by the router 102, which uses power availability predictions for at least one variable-power source 108 at least one processing site 110 to configure at least one individual processor within at least one processor cluster located at one of the at least one processing sites 110. The at least one variable-power source 108 may be any power source that captures naturally occurring energy and converts it to electrical power. For example, in some embodiments, the variable power sources 108 may comprise wind farms that generate electricity by using multiple wind turbines to convert the kinetic energy of wind into electrical energy, and the power predictions used by the router 102 may comprise wind patterns and measurements that allow the system 100 to predict the amount of electrical energy that can be generated at one or more processing sites 110 over one or more timescales. In other embodiments, the variable power sources 108 may comprise solar farms that generate electricity by using arrays of solar panels to capture sunlight and convert it into electrical energy. Similar to wind-driven power sources, the power predictions used by the router 102 may comprise solar irradiance patterns and measurements that allow the system 100 to predict the amount of electrical energy that can be generated at one or more processing sites 110 over one or more timescales.

Embodiments of the system 100 are also contemplated in which different processing sites 110 may utilize different types of variable-power sources 108, or individual processing sites 110 may incorporate multiple types of variable-power sources 108 to power co-located processor clusters 106 at the individual processing sites 110.

Each processor cluster 106 is a group of interconnected processors that are physically stored together at a processing site 110. The individual processors may be graphics processing units (“GPUs”), tensor processing units (“TPUs”), neural processing units (“NPUs”), central processing units (“CPUs”), application-specific integrated circuits (“ASICs”), or any other type of processor that can be configured to process AI inference workloads.

The router 102 receives at least one workload 104 in an arrival queue and routes it to the appropriate processing site 110 based on at least one workload characteristic and predicted power availability at one or more processing sites 110 over at least one timescale.

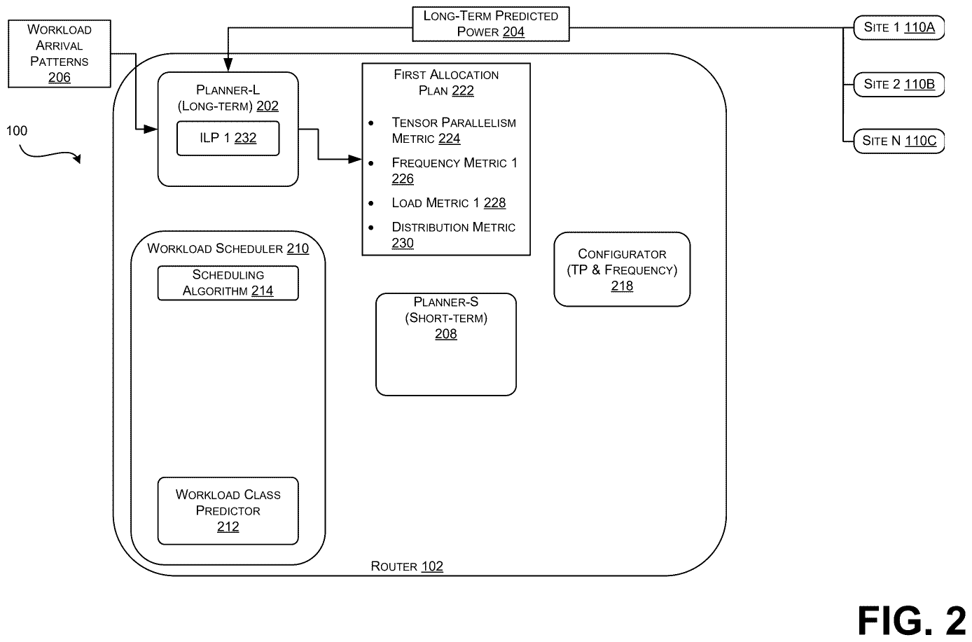

FIG. 2 illustrates details of the router 102 and a portion of the workload routing process. The router 102 is comprised of a long-term planner (“Planner-L”) 202, a short-term planner (“Planner-S”) 208, a configurator 218, and a workload scheduler 210. These components are each discussed in greater detail below along with the corresponding figures.

Planner-L 202 operates on a first, longer timescale relative to Planner-S 208. It uses a first at least one integer linear program (“ILP”) 232 to perform a first at least one ILP calculation and generate a first allocation plan 222 that specifies the allocation of at least one processor 502 in at least one processor cluster 106 to at least one processor instance 506.

An ILP is a type of mathematical optimization problem where the objective is to maximize or minimize a linear function, subject to a set of linear constraints, and all or some of the variables are restricted to be integers. The goal of the first at least one ILP is to minimize the aggregate end-to-end latency for a workload. The ILP variables and constraints for the first at least one ILP are as follows:

| Notation | Description |
|---|---|
| C, T | Set of workload classes and TP degrees |
| F, L | Set of all frequencies and loads (requests/s) |
| S | Set of wind farm sites |
| R_{L} | Limit on reconfigurations |
| Nₛ, Pₛ | Number of GPUs (right-sizing, §2.2) and power at site s (from real traces) |
| Load_{c} | Peak load for class c (from prod. trace) |
| TP_GPU (t) | Number of GPUs for TP degree t |
| e2e (c, f, t, l) | End-to-end latency and power for class c, frequency f, TP t, load l (from |
| power (c, f, t, l) | profiling exercise- lookup table) |
| Old_{c, f, t, s, l} | Number of GPUs in previous iteration for a {c, f, t, s, l} |
| GPU_{s, c, t} | Number of GPUs assigned to {s, c, t} |
| X_{c, f, t, s, l} | Number of instances for a {c, f, t, s, l} |
| Y_{c, f, t, s, l} | Binary flag set if at least one instance assigned for a {c, f, t, s, l} |
| R_{c, f, t, s, l} | Number of reconfigurations for a {c, f, t, s, l} |
| Z_{c, f, t, s, l} | Number of GPUs calculated by Planner-S |

ILP Variable: X_{c,f,t,s,l}
Objective: Minimize

$${\sum }_{c ∈ C , f ∈ F} {\sum }_{t ∈ T , s ∈ S , l ∈ L} Xc , f , t , s , l \cdot e 2 e ( c , f , t , l )$$

### Constraints:

(1) GPU per site within limit:

$$∀ s ∈ S , {\sum }_{c ∈ C , f ∈ F , t ∈ T , l ∈ L} Xc , f , t , s , l \cdot {TP}_{GPU} ( t ) \leq Ns$$

(2) Power per site within limit:

$$∀ s ∈ S , {\sum }_{c ∈ C , f ∈ F , t ∈ T , l ∈ L} Xc , f , t , s , l \cdot power ( c , f , t , l ) \leq Ps$$

(3) Enough serving capacity for each class:

$$∀ c ∈ C , {\sum }_{s ∈ S , f ∈ F , t ∈ T , l ∈ L} Xc , f , t , s , l \cdot l \geq Loadc$$

(4) One configuration of f and l:

$$∀ s ∈ S , c ∈ C , t ∈ T , {\sum }_{f ∈ F , l ∈ L} Yc , f , t , s , l \leq 1$$

(5) Expressing Y in terms of X:

$$∀ s ∈ S , c ∈ C , t ∈ T , f ∈ F , l ∈ L , 1 \geq Yc , f , t , s , l \geq \frac{Xc , f , t , s , l}{sum ( NS )}$$

(6) Number of reconfigurations are bounded:

$${\sum }_{c ∈ C , f ∈ F} {\sum }_{t ∈ T , s ∈ S , l ∈ L} Rc , f , t , s , l \leq RL$$

(7) Expressing R_{c,f,t,s,l}, ∀s∈S, c∈C, t∈T, f∈F, l∈L,

R_{c,f,t,s,l}≥Old_{c,f,t,s,l}−X_{c,f,t,s,l},R_{c,f,t,s,l}≥X_{c,f,t,s,l}−Old_{c,f,t,s,l}

Each processor instance 506 is a group of at least one physical processor 502 configured to work in unison on at least one workload 104. Each processor instance 506 is also configured to handle a different class of workload request over the first, longer timescale. Workload classes are determined based on at least one workload characteristic, such as an input length of a user's inference request and a predicted output length of a response from an inference model. For example, a workload comprising a short input and a predicted short output length (explained in more detail below) would be classified as a “short:short” workload.

As shown in FIG. 2, Planner-L 202 first receives at least one workload arrival pattern 206. A workload arrival pattern is comprised of a predicted number of workloads 104 over at least one timescale and at least one predicted workload characteristic 904 for each workload 104 in the predicted number of workloads. Planner-L 202 also receives long-term predicted power availability 204 over the first, longer timescale from at least one processing site 110 in the system 100. Planner-L 202 then uses the at least one workload arrival pattern 206 and the long-term predicted power availability 204 from the at least one processing site 110 to perform a first ILP calculation to generate a first allocation plan 222. The first allocation plan 222 comprises at least four metrics: a tensor parallelism (“TP”) metric 224 and a first frequency metric 226, both used for configuring individual processors 502 and processor instances 506 at processing sites 110, as well as a first load metric 228 and a distribution metric 230, which are used by the router 102 to route workloads 104 that each comprise at least one AI inference request.

The TP metric 224 is based on the amount of power that is expected to be available at one or more processing sites 110 over the first, longer timescale, and it specifies the number of processors 502 in at least one physical processor cluster 106 that will be allocated to form at least one processor instance 506. Each processor instance 506 is configured to process at least one class of workload 104. The first frequency metric 226 is also based on the amount of power that is expected to be available at one or more processing sites 110 over the first, longer timescale, and it specifies at least one maximum operating frequency for the allocated processors 502 over the first, longer timescale.

In some embodiments, Planner-L 202 is configured to calculate the TP metric 224 and the first frequency metric 226 with the goal of minimizing end-to-end workload processing latency. In other embodiments, Planner-L 202 is configured to calculate the TP metric 224 and the first frequency metric 226 with the goal of minimizing power consumption for workload processing.

The first load metric 228 specifies the number of workloads per second that should be routed to at least one processor instance 506 over the first, longer timescale. The distribution metric 230 specifies a fraction of workloads per class that should be routed to each of the at least one processor instances 506 across each of the at least one processing sites 110 in the system 100.

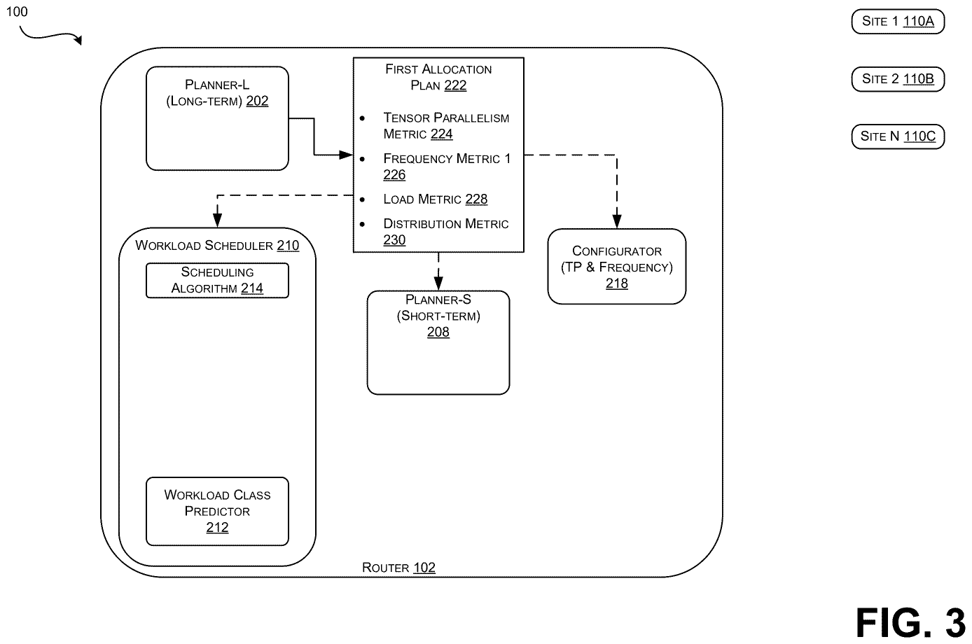

FIG. 3 illustrates a portion of the system 100 showing additional operations performed by the router 102. Once Planner-L has generated the first allocation plan 222 comprising the TP metric 224, the first frequency metric 226, the first load metric 228, and the distribution metric 230, the first allocation plan 222 is received by Planner-S 208, the configurator 218, and the workload scheduler 210. In some embodiments, the workload scheduler 210 may only receive a subset of the metrics in the first allocation plan 222 instead of the entire first allocation plan 222. In other embodiments, the workload scheduler 210 may receive a modified version of Planner-S's output (not shown), comprising at least one metric from the first allocation plan 222 rather than directly receiving the first allocation plan 222.

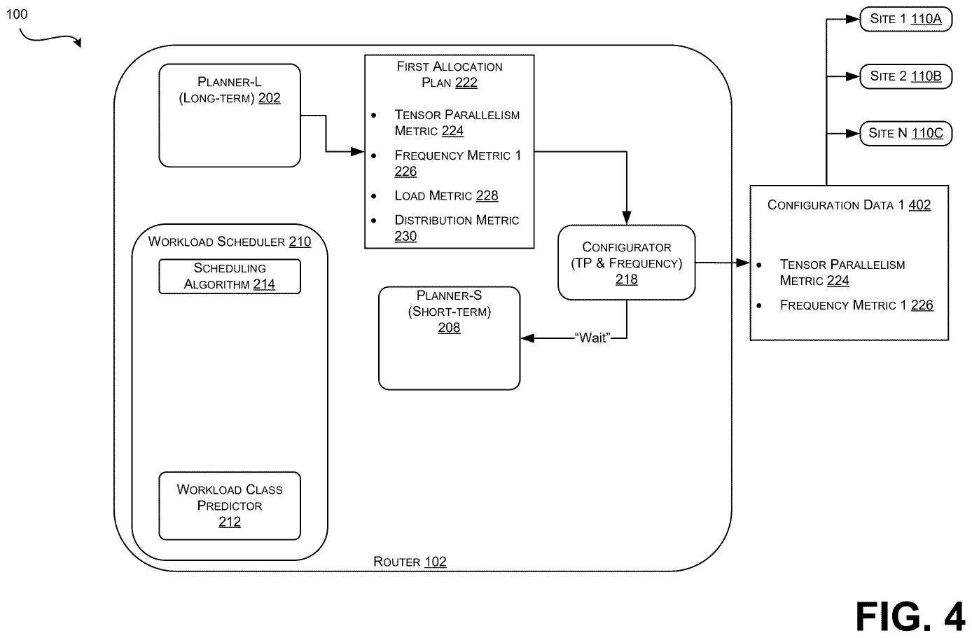

FIG. 4 illustrates a portion of the system 100 showing additional operations performed by the router 102. Upon receiving the first allocation plan 222 from Planner-L 202, the configurator 218 generates a first set of configuration data 402 comprising the TP metric 224 and the first frequency metric 226 from the first allocation plan 222. The configurator 218 sends the first set of configuration data 402 to the at least one processing site 110 in the system 100 where at least one site-wise scheduler and configurator 504 receives the first set of configuration data 402 and uses it to configure at least one processor 502 in at least one processor cluster 106 of the at least one processing site 110.

After receiving the first allocation plan 222 from Planner-L 202, the configurator 218 may also restrain Planner-S 208 from performing any reconfiguration operations (discussed below) on at least one processor 502 or at least one processor instance 506 in a processor cluster 106 that is pending configuration or reconfiguration based on the first allocation plan 222. Planner-S 208 operates on a second, shorter timescale than Planner-L 202 and is responsible for updating the maximum processor frequency and the processor instance 506 workloads per second that are specified by the first allocation plan 222. In some instances, the configurator 218 must wait for at least one workload 104 to finish running on at least one processor instance 506 before it can reconfigure at least one processor 502 based on the first allocation plan 222. This requires that Planner-S 208 also wait for the at least one processor instance 506 to be configured based on the first allocation plan 222 before it attempts to update the at least one maximum operating frequency for the allocated processors and the number of workloads per second that should be routed to the at least one processor instance 506 as specified by the first allocation plan 222.

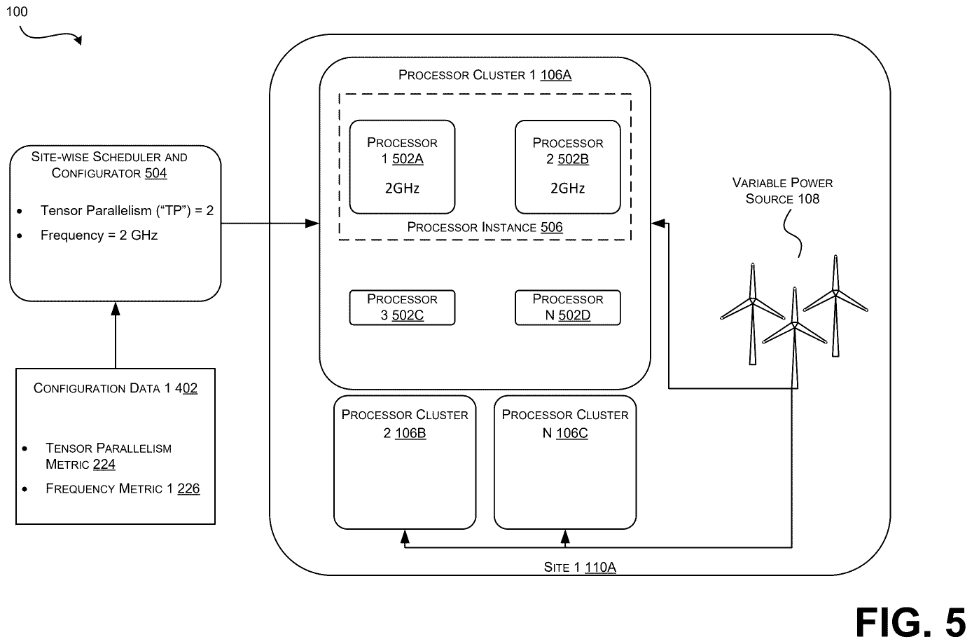

FIG. 5 illustrates a portion of the system 100 showing details of an illustrative processing site 110. Processing sites 110 comprise at least one processor cluster 106, which is co-located with at least one distinct variable-power source 108. The at least one distinct variable-power source 108 can include any type of energy generated from naturally replenishing sources, such as solar power, wind power, hydropower, or geothermal energy. Each processor cluster 106 comprises at least one processor, such as a GPU, TPU, NPU, CPU, or ASIC. The at least one processor 502 of each processor cluster 106 can be configured as at least one processor instance 506 based on the first allocation plan 222 that is generated by Planner-L 202.

Specifically, FIG. 5 shows a site-wise scheduler and configurator 504 at a first processing site 110A receiving the first set of configuration data 402 that was generated by the configurator 218 based on the first allocation plan 222. The first set of configuration data 402 comprises the TP metric 224 and the first frequency metric 226 from the first allocation plan 222. The TP metric 224 and first frequency metric 226 are being used by the site-wise scheduler and configurator 504 to configure the tensor parallelism for the processor instance 506 and the maximum frequency at which the processors 502 allocated to the processor instance 506 can operate over the first, longer timescale.

Additionally, FIG. 5 shows a TP metric of “2” resulting in a first processor 502A and a second processor 502B—out of four processors 502 available in a first processor cluster 106A—being allocated to a processor instance 506, resulting in a processor instance 506 with a tensor parallelism of two. Additionally, the two processors 502 in the processor instance 506 are shown as being configured with a maximum frequency of 2 GHz over the first, longer timescale based on the first frequency metric 226 from the first allocation plan 222.

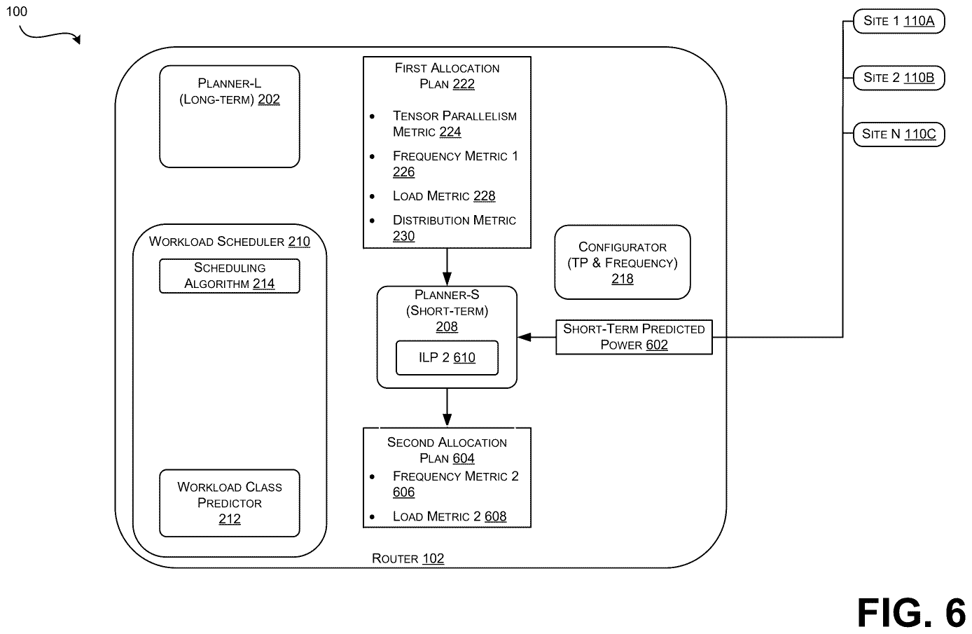

FIG. 6 illustrates a portion of the system 100 showing additional operations performed by the router 102. As described above, Planner-S 208 operates on a second, shorter timescale relative to Planner-L 202. FIG. 6 shows Planner-S 208 receiving both the first allocation plan 222 generated by Planner-L 202 and short-term predicted power availability 602 from at least one processing site 110 in the system 100. Planner-S 208 uses a second at least one ILP 610 to perform a second at least one ILP calculation and generate a second allocation plan 604 based on the first allocation plan 222 and the short-term predicted power availability 602. The second at least one ILP has the same optimization goal as the first at least one ILP—to minimize the aggregate end-to-end latency for the workload. The ILP variables and constraints for the second at least one ILP are as follows:

| Notation | Description |
|---|---|
| C, T | Set of workload classes and TP degrees |
| F, L | Set of all frequencies and loads (requests/s) |
| S | Set of wind farm sites |
| R_{L} | Limit on reconfigurations |
| Nₛ, Pₛ | Number of GPUs (right-sizing, §2.2) and power at site s (from real traces) |
| Load_{c} | Peak load for class c (from prod. trace) |
| TP_GPU (t) | Number of GPUs for TP degree t |
| e2e (c, f, t, l) | End-to-end latency and power for class c, frequency f, TP t, load l (from |
| power (c, f, t, l) | profiling exercise- lookup table) |
| Old_{c, f, t, s, l} | Number of GPUs in previous iteration for a {c, f, t, s, l} |
| GPU_{s, c, t} | Number of GPUs assigned to {s, c, t} |
| X_{c, f, t, s, l} | Number of instances for a {c, f, t, s, l} |
| Y_{c, f, t, s, l} | Binary flag set if at least one instance assigned for a {c, f, t, s, l} |
| R_{c, f, t, s, l} | Number of reconfigurations for a {c, f, t, s, l} |
| Z_{c, f, t, s, l} | Number of GPUs calculated by Planner-S |

ILP Variable: Z_{c,f,t,s,l}
Objective: Minimize

$${\sum }_{s ∈ S , c ∈ C , t ∈ T} {\sum }_{f ∈ F , l ∈ L} Zc , f , t , s , l \cdot e 2 e ( c , f , t , l )$$

### Constraints:

(1) Power per site within limit:

$$∀ s ∈ S , {\sum }_{c , f , t , l} Zc , f , t , s , l \cdot power ( c , f , t , l ) \leq Ps$$

(2) Enough serving capacity for each class:

$$∀ c ∈ C , {\sum }_{s ∈ S , f ∈ F , t ∈ T , l ∈ L} Zc , f , t , s , l \cdot l \geq Loadc$$

(3) Limiting number of GPUs per config:

$$∀ s ∈ S , c ∈ C , t ∈ T , {\sum }_{l ∈ L , f ∈ F} Zc , f , t , s , l \leq GPUs , c , t$$

The second allocation plan 604 comprises a second frequency metric 606 and a second load metric 608. The second frequency metric 606 is based on the amount of power that is expected to be available at one or more processing sites 110 over the second, shorter timescale and specifies an adjustment to the at least one maximum processor frequency that was based on the first frequency metric 226 of the first allocation plan 222.

Because Planner-L operates on a first, longer timescale, it sacrifices some efficiency in predicting site-wise power availability. The frequency adjustment specified by the second frequency metric 606 is based on the second, shorter timescale, which allows the at least one processor 502 allocated to the at least one processor instance 506 to make near real-time use of short-term increases in predicted available power at the corresponding processing site 110 to run faster and process workloads 104 at an increased rate. Similarly, the second load metric 608 capitalizes on increased power availability over the second, shorter timescale by specifying an update to the number of workloads 104 that are to be routed to at least one processor instance 506 to take advantage of the increased processing speed.

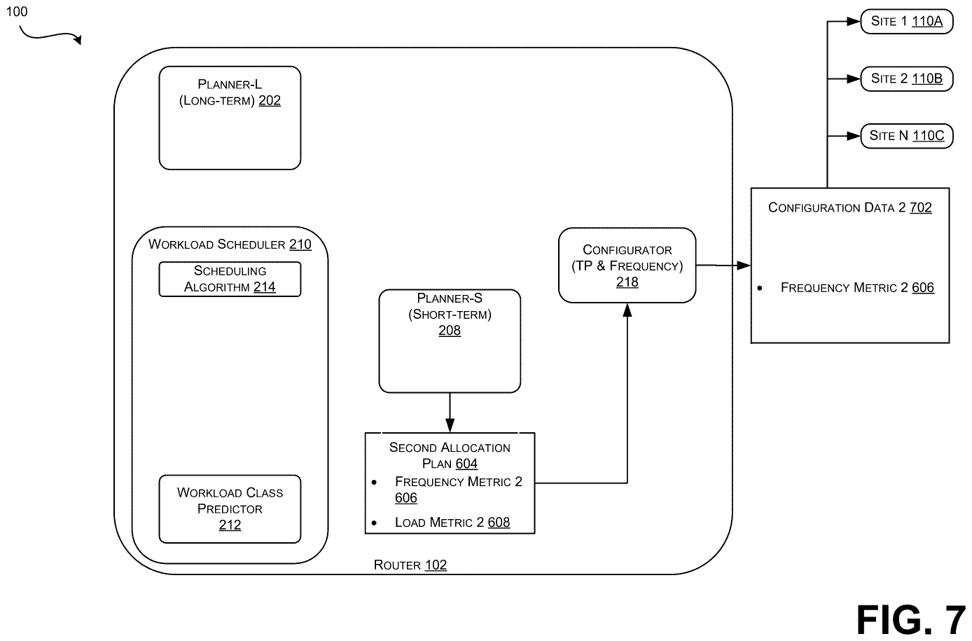

FIG. 7 illustrates a portion of the system 100 showing additional operations performed by the router 102. Upon receiving the second allocation plan 604 from Planner-S 208, the configurator 218 generates a second set of configuration data 702 comprising the second frequency metric 606 from the second allocation plan 604. The second set of configuration data 702 is then sent to at least one processing site 110 where at least one site-wise scheduler and configurator 504 receives it and uses it to update the frequency of at least one processor 502 that was specified by the first frequency metric 226 in the first allocation plan 222. As described above, this configuration update allows the at least one allocated processor 502 in the at least one processor instance 506 to make use of any increases in predicted available power over the second, shorter timescale to increase the output of the at least one processor.

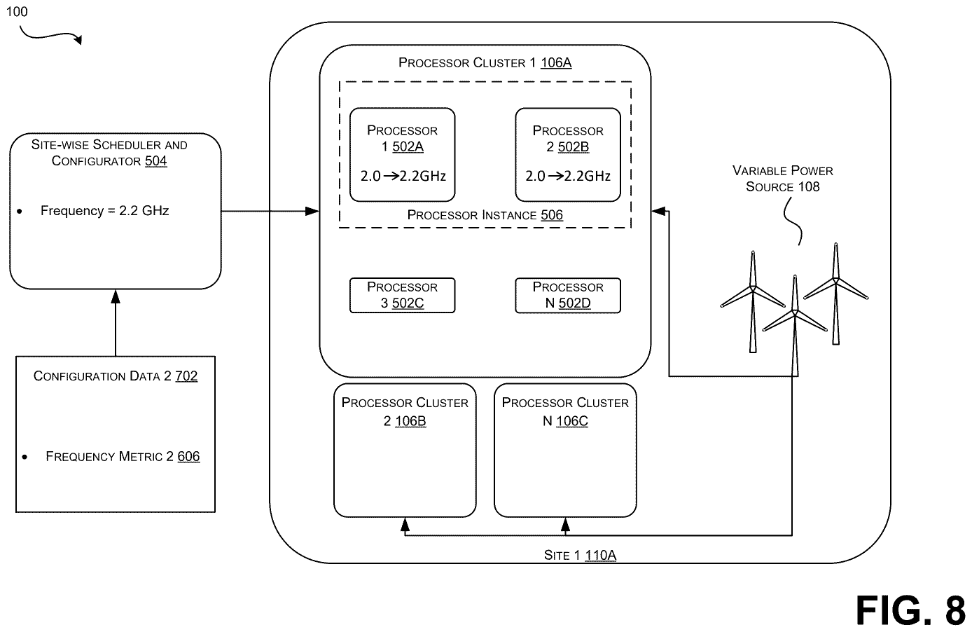

FIG. 8 illustrates a portion of the system 100 showing additional details of an illustrative processing site 110. Specifically, FIG. 8 shows the site-wise scheduler and configurator 504 at a first processing site 110A receiving the second set of configuration data 702 that was generated by the configurator 218 based on the second allocation plan 604. The second set of configuration data 702 comprises the second frequency metric 606 from the second allocation plan 604. The site-wise scheduler and configurator 504 adjusts the frequency of the processor 502 allocated to the processor instance 506 based on the second frequency metric 606 in the second set of configuration data 702. As shown in FIG. 8, the site-wise scheduler and configurator 504 of the first processing site 110A is reconfiguring a first processor 502A and a second processor 502B allocated to processor instance 506 to run at an increased frequency of 2.2 GHz instead of the 2.0 GHz that was specified by the first frequency metric 226 in the first set of configuration data 402.

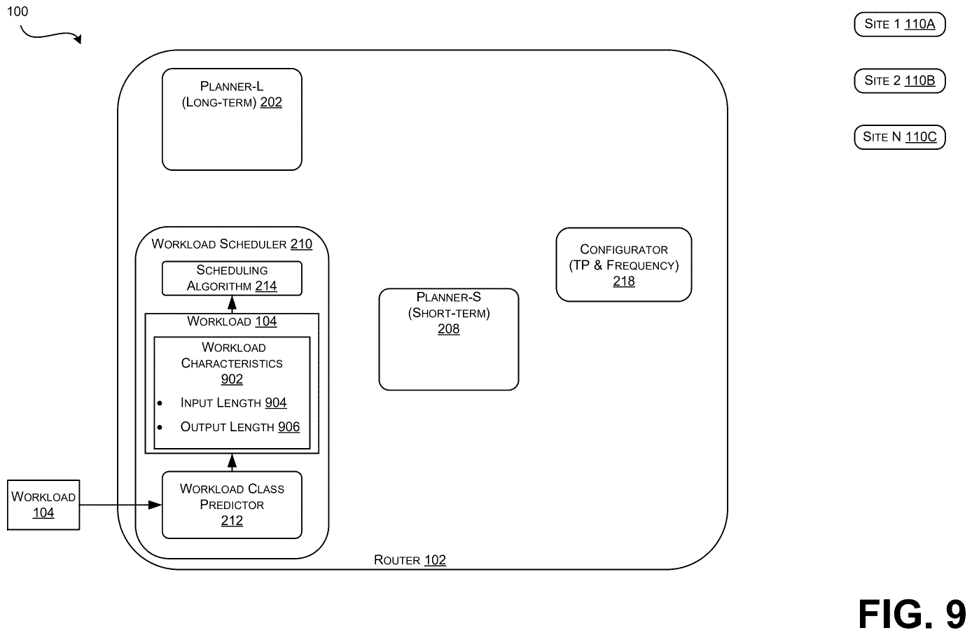

FIG. 9 illustrates a portion of the system 100 showing additional operations performed by the router 102. Specifically, FIG. 9 shows the router 102 in a state where at least one processor instance 506 has been configured and the router 102 is receiving a workload 104. After the at least one processor instance 506 has been configured for each workload class at one or more processing sites 110, the workload scheduler 210 receives the at least one workload 104 to be routed to a specific processor instance 506 at a specific processing site 110 that corresponds to the class of the workload 104.

A workload class predictor 212 in the workload scheduler 210 analyzes the one or more inference requests of the workload 104, i.e., one or more user input queries, as well as the inference model being run on the one or more processor instances 506, and predicts an output length 906 of the model's response to determine the workload characteristics 902 and corresponding class of the workload 104. Specifically, the workload class predictor 212 uses an embedding layer to convert input data into numerical representations that capture relevant patterns and relationships. These embeddings serve as a compact form of the input data. The workload class predictor 212 then uses a regressor to take these embeddings as inputs and apply mathematical techniques to predict the output length of the inference model's output response.

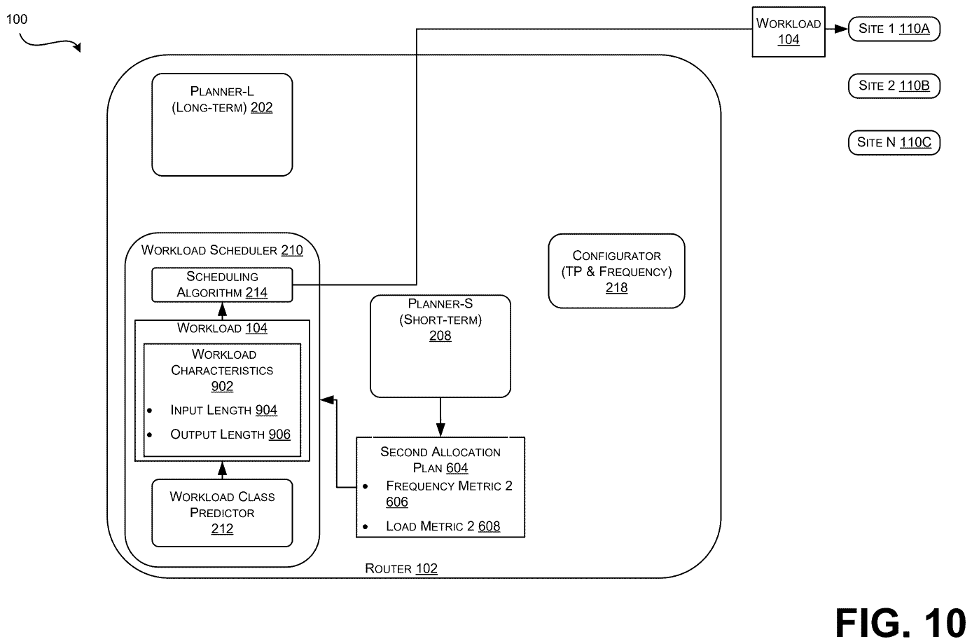

FIG. 10 illustrates a portion of the system 100 showing additional operations performed by the router 102. Specifically, FIG. 10 shows the system 100 in a state after at least one workload characteristic 902 has been determined for at least one workload 104 received by the router 102. The workload scheduler 210 uses the second allocation plan 604 output by Planner-S 208 to determine at least one weight for at least one class of workload 104. The at least one weight for the at least one class of workload 104 is then used with at least one scheduling algorithm 214, e.g., weighted round-robin, least connections, least response time, consistent hashing, etc., to route the at least one workload 104 to a processor instance 506 that is configured to process the specific workload class corresponding to the at least one workload characteristic 902 of the at least one workload 104.

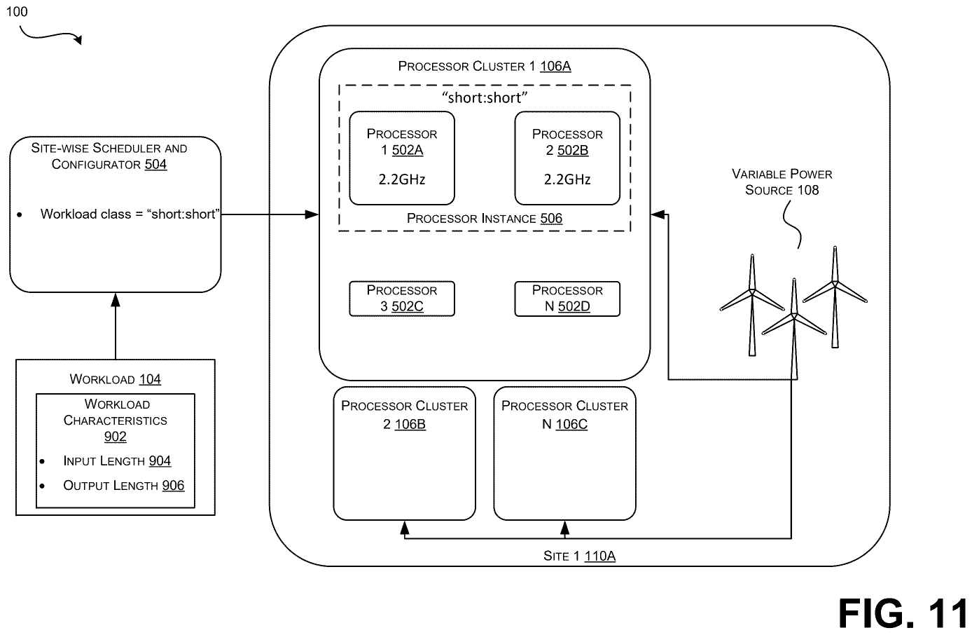

FIG. 11 illustrates a portion of the system 100 showing additional details of an illustrative processing site 110. The site-wise scheduler and configurator 504 at the first processing site 110A receives a workload 104 that is routed to the first processing site 110A by the workload scheduler 210. Specifically, the workload 104 is routed to the first processing site 110A based on at least one workload characteristic 902 of the workload 104 and the second load metric 608 of the second allocation plan 604. The site-wise scheduler and configurator 504 then routes the workload 104 to a processor instance 506 at the first processing site 110A that is configured to process workloads 104 in the workload class corresponding to at least one workload characteristic 902 of the received workload 104.

Specifically, FIG. 11 shows the received workload 104 with the workload characteristics 902, i.e., an input length 904 and output length 906, corresponding to a workload class of “short:short.” In inference models, input length and output length refer to the size of the data provided to the model and the size of the model's generated response. These lengths are measured in different ways depending on the type of data the model is processing. For example, with models handling text data, such as large language models (“LLMs”), input and output lengths are typically measured in tokens. Tokens represent segments of text like words, subwords, or characters. However, in models that process images, input length may refer to the resolution or number of pixels, while output length could correspond to the number of detected objects or classified categories. Similarly, for audio models, input length may be defined by the duration of the audio or the number of audio samples, and output length may represent a transcript or classification label. In the illustrative example shown in FIG. 11, the workload characteristics and corresponding workload class of “short:short” refer to the relative token counts of a user's input and an LLM's output, respectively.

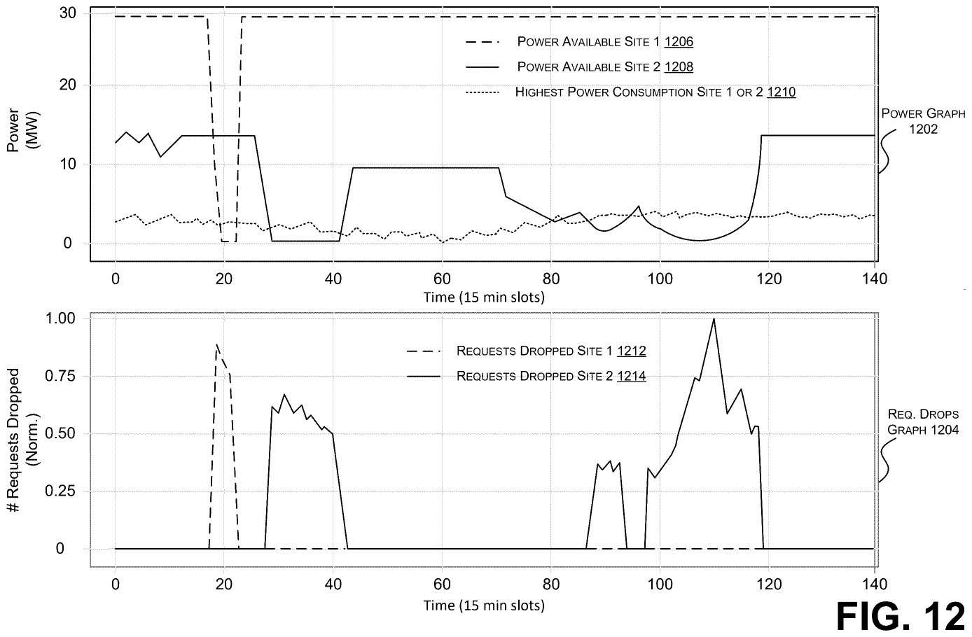

FIG. 12 illustrates the power complementarity issue addressed by the techniques described herein. Power complementarity refers to the concept of multiple power-producing sites generating electricity in a way that their outputs balance or support one another. In the context of processing inference workloads at sites using variable-power sources, different power sources may experience fluctuating levels of power generation at different times. Power complementarity occurs when a reduction in output at one site is offset by an increase in output at another, resulting in a more stable and reliable overall power supply. As shown in FIG. 12, state-of-the-art solutions fail to effectively leverage power complementarity between processing sites 110, leading to unnecessary dropped requests that could have been avoided using the techniques disclosed herein.

The power graph 1202 depicts the level of power 1206 produced by a variable-power source 108 at a first processing site 110A (e.g., a collection of wind turbines in Iceland), as well as the level of power 1208 produced by a variable-power source at a second processing site 110B (e.g., a separate and distinct collection of wind turbines in northern Great Britain). Additionally, the power graph 1202 displays the highest level of power consumption 1210 recorded at either the first or second processing site. The corresponding request drops graph 1204 shows the normalized number of dropped requests at each site over the same timescale as the site-wise power production shown in the power graph 1202. When a site's power consumption exceeds its available power, the result is insufficient energy to support processing hardware, leading to dropped workload requests.

For example, at time 20, the request drops graph 1204 shows a spike in dropped requests at the first processing site 110A. At the same time, the power graph 1202 indicates that the level of power produced at the first processing site 110A fell below the highest level of power consumption 1210. This confirms that the first processing site 110A experienced a reduction in power output while simultaneously experiencing a level of power consumption somewhere between the first site's decreased power output level and the highest level of power consumption 1210 between the two sites, thereby contributing to a substantial increase in dropped requests at the first processing site.

Notably, the power graph 1202 also shows that at time 20, the second processing site 110B was producing between 10 MW and 15 MW of power more than sufficient to support the highest level of power consumption 1210 recorded at either site, which was less than 5 MW. Using the techniques disclosed herein, the router 102 would have predicted the power reduction at the first processing site 110A over either the first, longer timescale or the second, shorter timescale. By leveraging power complementarity, the router 102 could have dynamically rerouted the dropped requests from the first processing site 110A to the second processing site 110B, where sufficient power was available to prevent dropped requests and maintain system performance.

### Illustrative Method

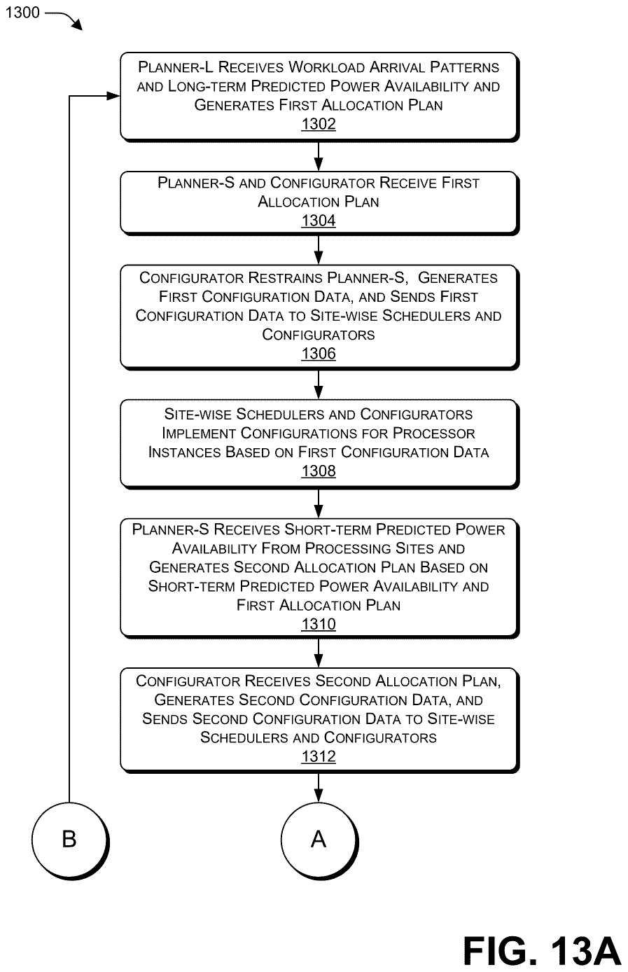

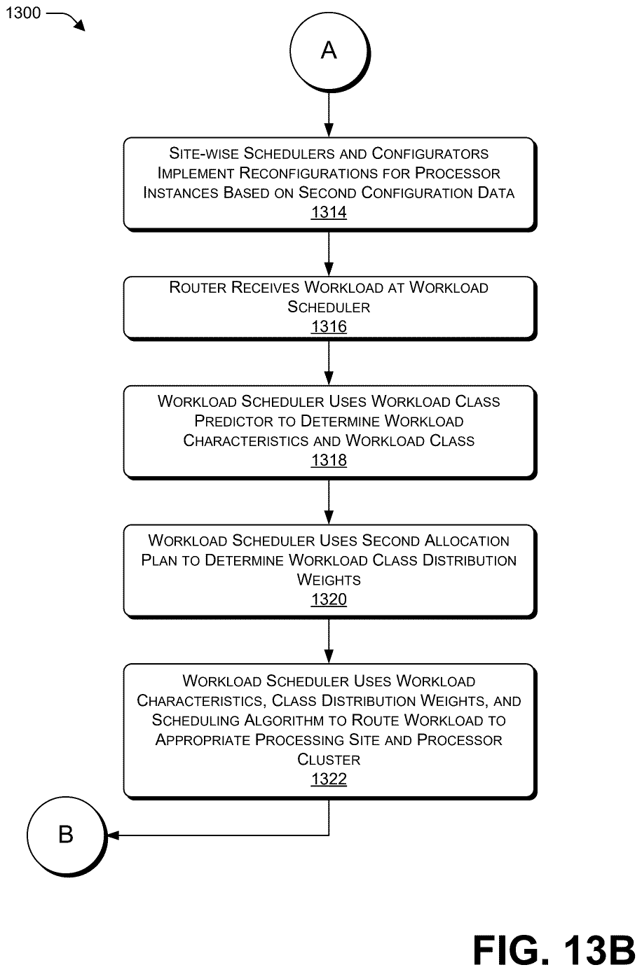

FIGS. 13A and 13B illustrate aspects of a process 1300 for powering AI, and other computing workloads, by locating processing power near variable-power sources. The process 1300 may be implemented with any of the architectures shown in FIGS. 1-12.

The process 1300 begins at operation 1302 when Planner-L 202 receives one or more workload arrival patterns 206 and long-term predicted power availability 204 from one or more distinct variable-power sources 108 at one or more processing sites 110 over a first, longer timescale. Planner-L 202 then generates a first allocation plan 222 based on the one or more workload arrival patterns 206 and the long-term predicted power availability 204 from the one or more distinct variable-power sources 108.

In some implementations, the first allocation plan 222 is generated using a first integer linear program 232 and comprises a tensor parallelism metric 224 and a first processor frequency metric 226 that is based on the first, longer timescale. In some implementations, the one or more workload arrival patterns may also comprise a predicted number of discrete workloads (“workloads”) 104 and a workload characteristic 902 prediction for each of the predicted number of workloads 104 comprising an input length classification 904 and an output length classification 906.

The process 1300 then proceeds to operation 1304 where Planner-S 208 and a configurator 218 receive the first allocation plan 222 from Planner-L 202.

Next, the process 1300 proceeds to operation 1306 where the configurator 218 restrains Planner-S 208; generates a first set of configuration data 402 comprising the TP metric 224 and the first processor frequency metric 226 based on the first, longer timescale; and sends the first set of configuration data 402 to site-wise schedulers and configurators 504 located at processing sites 110 within the system 100.

The process 1300 then proceeds to operation 1308 where the site-wise schedulers and configurators 504 implement configurations for processor instances 506 according to the first set of configuration data 402 received from the configurator 218.

Next, the process 1300 proceeds to operation 1310 where Planner-S 208 receives short-term predicted power availability 602 from the processing sites 110 and generates a second allocation plan 604 based on the short-term predicted power availability 602 over a second, shorter timescale and the first allocation plan 222. In some implementations, the second allocation plan 604 is generated using a second integer linear program 610 and comprises a processor frequency metric 606 based on the second, shorter timescale.

The process 1300 then proceeds to operation 1312 where the configurator 218 receives the second allocation plan 604 from Planner-S 208; generates a second set of configuration data 702 comprising the processor frequency metric 606 based on the second, shorter timescale; and sends the second set of configuration data 702 to the site-wise schedulers and configurators 504. In some implementations, the configurator 218 configures individual processors 502 in one or more processor clusters 106 based on the tensor parallelism metric 224 and the first processor frequency metric 226 of the first allocation plan 222, and the other processor frequency metric 606 of the second allocation plan 604.

Next, the process 1300 proceeds to operation 1314 in FIG. 13B where the site-wise schedulers and configurators 504 implement reconfigurations for processor instances 506 according to the second set of configuration data 702 received from the configurator 218.

The process 1300 then proceeds to operation 1316 where a workload scheduler 210 of the router 102 receives one or more workloads 104. In some implementations, each of the one or more workloads 104 comprises one or more AI inference requests.

The process 1300 next proceeds to operation 1318 where the workload scheduler 210 uses a workload class predictor 212 to determine one or more workload characteristics 902 and a workload class for the workload 104. In some implementations, the workload scheduler (210) comprises the workload class predictor 212, and the one or more workload characteristics (902) further comprise an input length classification 904 and an output length classification 906 for each of the one or more workloads 104.

The process 1300 then proceeds to operation 1320 where the workload scheduler 210 uses the second allocation plan 604 to determine workload class distribution weights.

Next, the process 1300 proceeds to operation 1322 where the workload scheduler 210 uses the workload characteristics 902 and the class distribution weights with a scheduling algorithm 214 to route each of the one or more workloads 104 to a specific processing site 110 and processor cluster 106.

In some implementations, the workload scheduler 212 uses a weighted round-robin scheduling algorithm 214 to allocate each of the one or more workloads 104 to a specific processing site 110 and processing cluster 106 based on the one or more workload characteristics 902, wherein the one or more workload characteristics 902 comprise an input length classification 904 and an output length classification 906 for each of the one or more workloads 104. In some implementations, each of the one or more workloads 104 is routed to a specific processor instance 506 in the specific processor cluster 106 at the specific processing site 110. In some implementations, each of the one or more workloads 104 is received at the specific processing site 110 by a site-wise scheduler and configurator 504 that further routes each workload 104 to the specific processor cluster 106 and processor instance 506 as directed by the workload scheduler 212.

The process 1300 then returns to operation 1302 on FIG. 13A where it repeats until no more workloads 104 are predicted to arrive, no more power is available, or a user specifies termination of the process.

### Illustrative Computing Architectures and Environments

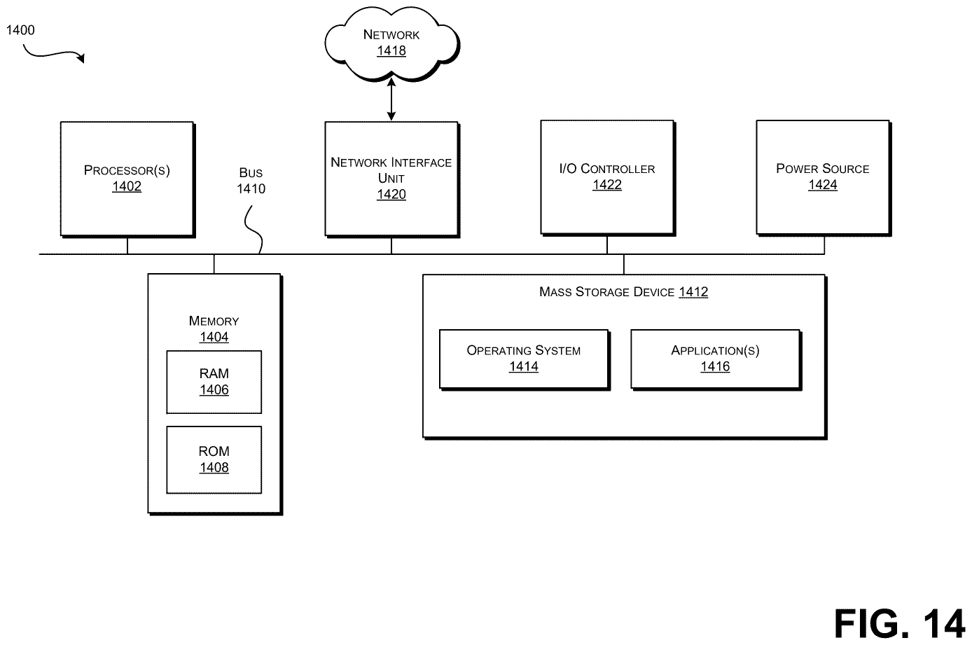

FIG. 14 shows additional details of an example computer architecture 1400 for a device, such as a computer or a server capable of executing computer instructions (e.g., a module or a program component described herein). The computer architecture 1400 illustrated in FIG. 14 includes processor(s) 1402, a system memory 1404, including a random-access memory 1406 (RAM) and a read-only memory (ROM) 1408, a system bus 1410 that couples the system memory 1404 to the processor(s) 1402, and a power source 1424. In various examples, the processor(s) 1402 are distributed. Stated another way, one processor 1402 may be located in a first location (e.g., a rack within a datacenter) while another processor 1402 is located in a second location separate from the first location. For example, the processor(s) 1402 can include graphical processing units (GPUs) for executing complex artificial intelligence models such as LLMs and LMMs. In some implementations, the processor(s) 1402 of the computer architecture 1400 may be the same processors 502 of processor clusters 106 located at processing sites 110. Moreover, the systems discussed herein can be provided as a distributed computing system such as a cloud service.

Processor(s) 1402 can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 1400, such as during startup, is stored in the ROM 1408. The computer architecture 1400 further includes a mass storage device 1412 on which an operating system 1414, application(s) 1416, and other data described herein are encoded.

Other data or modules that may be contained within the mass storage device 1412 include Planner-L 202, the configurator 218, Planner-S 208, the workload scheduler 210, and the workload class predictor 212. Planner-L 202 is configured to receive at least one workload arrival pattern, long-term predicted power availability from processing sites 110 and generate a first allocation plan 222 in response. The configurator 218 is configured to generate a first set of configuration data 402 in response to receiving the first allocation plan 222 and a second set of configuration data 702 in response to receiving the second allocation plan 604. The configurator 218 sends the first set of configuration data 402 and the second set of configuration data 702 to at least one site-wise scheduler and configurator 504 at one or more processing sites 110 in the system 100. Planner-S 208 is configured to receive both the first allocation plan 222 generated by Planner-L 202 and short-term predicted power availability 602 from at least one processing site 110 in the system 100 and generate the second allocation plan 604 in response. The workload scheduler 210 is configured to receive at least one workload 104 and route it to a specific processor instance 506 at a specific processing site 110 that corresponds with the class of the workload 104. Additionally, the workload scheduler 210 comprises a workload class predictor 212 that analyzes one or more inference requests of the at least one workload 104, i.e., one or more user input queries, as well as the inference model being run on the one or more processor instances 506. The workload class predictor 212 is then configured to predict an output length 906 of the model's response to determine the workload characteristics 902 and corresponding class of the workload 104.

Additional data or modules that may be contained in the mass storage device 1412 include a scheduling algorithm 214. The scheduling algorithm 214 is configured to utilize distribution weights specified by the second allocation plan 604 to route the at least one workload 104 to a processor instance 506 that is configured to process the specific workload class corresponding to the at least one workload characteristic 902 of the at least one workload 104.

The mass storage device 1412 is connected to processor(s) 1402 through a mass storage controller connected to the system bus 1410. The mass storage device 1412 and its associated computer-readable media provide non-volatile storage for the computer architecture 1400. Although the description of computer-readable media contained herein refers to a mass storage device, the computer-readable media can be any available computer-readable storage media or communication media that can be accessed by the computer architecture 1400.

Computer-readable media includes both computer-readable storage media and communication media. Computer-readable storage media includes one or more of volatile memory, nonvolatile memory, and/or other persistent and/or auxiliary computer storage media, removable and non-removable computer storage media implemented in any method or technology for encoding of information such as computer-readable instructions, data structures, program modules, or other data. Thus, computer-readable storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media embodies computer-readable instructions, data structures, program modules, or other data in a modulated data signal, such as a carrier wave, or other transmission mechanism. Computer-readable storage media and communication media are mutually exclusive. Thus, as defined herein, computer-readable storage media does not include communication media. That is, computer-readable storage media does not include media consisting solely of a modulated data signal, a carrier wave, or a propagated signal, per se.

According to various configurations, the computer architecture 1400 may operate in a networked environment using logical connections to remote computers through the network 1418. The computer architecture 1400 may connect to the network 1418 through a network interface unit 1420 connected to the system bus 1410. The computer architecture 1400 also may include an input/output controller 1422 for receiving and processing input from a number of other devices, including a keyboard, mouse, touch, or electronic stylus or pen. Similarly, the input/output controller 1422 may provide output to a display screen, a printer, or other type of output device.

The software components described herein may, when loaded into the processor(s) 1402 and executed, transform the processor(s) 1402 and the overall computer architecture 1400 from a general-purpose computing system into a special-purpose computing system customized to facilitate the functionality presented herein. The processor(s) 1402 may be constructed from any number of transistors or other discrete circuit elements, which may individually or collectively assume any number of states. More specifically, the processor(s) 1402 may operate as a finite-state machine, in response to executable instructions contained within the software modules disclosed herein and encoded on the mass storage device 1412. These computer-executable instructions may transform the processor(s) 1402 by specifying how the processor(s) transitions between states, thereby transforming the transistors or other discrete hardware elements constituting the processor(s) 1402.

The power source 1424 described herein may be a direct current (“DC”) power supply, an alternating current (“AC”) mains supply with conversion circuitry, or a battery-based system such as a lithium-ion or nickel-metal hydride battery. In some implementations, the power source 1424 may be a distinct variable-power source 108 co-located with at least one processor cluster at a processing site 110 and/or include energy harvesting components or redundant backup systems, such as uninterruptable power supplies (“UPSs”), to ensure continuous operation.

### Illustrative Embodiments

The following clauses describe multiple possible embodiments for implementing the features described in this disclosure. The various embodiments described herein are not limiting nor is every feature of any given embodiment required to be present in another embodiment. Any two or more of the embodiments may be combined together unless context clearly indicates otherwise. As used herein in this document “or” means and/or. For example, “A or B” means A without B, B without A, or A and B. As used herein, “comprising” means including all listed features and potentially including addition of other features that are not listed. “Consisting essentially of” means including the listed features and those additional features that do not materially affect the basic and novel characteristics of the listed features. “Consisting of” means only the listed features to the exclusion of any feature not listed.
Clause 1. A method for routing discrete workloads (104) to processor clusters (106) co-located with distinct variable-power sources (108) comprising: generating a first allocation plan (222) based on one or more workload arrival patterns (206) and long-term predicted power availability (204) on a first, longer timescale from one or more distinct variable-power sources (108); generating a second allocation plan (604) based on the first allocation plan (222), the one or more workload arrival patterns (206), and short-term predicted power availability (602) on a second, shorter timescale from the one or more distinct variable-power sources (108); and allocating the one or more discrete workloads (104) to one or more processor clusters (106) co-located with one of the distinct variable-power sources (108) based on the second allocation plan (604).
Clause 2. The method of clause 1, wherein the first allocation plan (222) comprises a tensor parallelism metric (224) and a processor frequency metric (226) that is based on the first, longer timescale.
Clause 3. The method of clause 2, wherein the second allocation plan (604) comprises an other processor frequency metric (606) based on the second, shorter timescale.
Clause 4. The method of clause 3, further comprising: configuring individual processors (502) in the one or more processor clusters (106) based on the tensor parallelism metric (224) and the processor frequency metric (226) of the first allocation plan (222); and updating the configuration of the individual processors (502) based on the other processor frequency metric (606) of the second allocation plan (604).
Clause 5. The method of any of clauses 1 to 4, wherein the one or more workload arrival patterns (206) comprise a predicted number of discrete workloads (104) and a discrete workload characteristic (902) prediction for each of the predicted number of discrete workloads (104) comprising an input length classification (904) and an output length classification (906).
Clause 6. The method of any of clauses 1 to 5, wherein the first allocation plan (222) is generated using a first integer linear program (232) and the second allocation plan (604) is generated using a second integer linear program (610).
Clause 7. The method of any of clauses 1 to 6, wherein each of the one or more discrete workloads (104) comprises one or more AI inference requests.
Clause 8. A system comprising one or more processors and memory coupled to the processors containing instructions that, when executed, cause the system to perform the method of any of clauses 1 to 7.
Clause 9. Computer-readable storage media comprising instructions stored in a memory that when executed by a processor cause a computing device to perform the method of any of clauses 1 to 7.
Clause 10. A system (100) for routing discrete workloads (104) to processor clusters (106) co-located with distinct variable-power sources (108) comprising: one or more processors (502); memory (1406) coupled to the one or more processors (502); a long-term planner (202) configured to generate a first allocation plan (222) based on one or more workload arrival patterns (206) and long-term predicted power availability (204) on a first, longer timescale from one or more distinct variable-power sources (108); a short-term planner (208) configured to generate a second allocation plan (604) based on the first allocation plan (222), the one or more workload arrival patterns (206), and short-term predicted power availability (602) on a second, shorter timescale from the one or more distinct variable-power sources (108); and a workload scheduler (210) configured to allocate the one or more discrete workloads (104) to one or more processor clusters (106) co-located with distinct variable-power sources (108) based on the second allocation plan (604).
Clause 11. The system (100) of clause 10, wherein the first allocation plan (222) comprises a tensor parallelism metric (224) and a processor frequency metric (226) that is based on the first, longer timescale.
Clause 12. The system of clause 11, wherein the second allocation plan (604) comprises an other processor frequency metric (606) based on the second, shorter timescale.
Clause 13. The system of clause 12, further comprising a configurator (218) configured to configure individual processors (502) in the one or more processor clusters (106) based on the tensor parallelism metric (224) and the processor frequency metric (226) of the first allocation plan (222) and the other processor frequency metric (606) of the second allocation plan (604).
Clause 14. The system (100) of clauses 10 to 13, wherein the one or more workload arrival patterns (206) comprise a predicted number of discrete workloads (104) and a discrete workload characteristic (902) prediction for each of the predicted number of discrete workloads (104) comprising an input length classification (904) and an output length classification (906).
Clause 15. The system (100) of clauses 10 to 14, wherein the workload scheduler (210) comprises a discrete workload class predictor (212) configured to determine one or more discrete workload characteristics (902) comprising an input length classification (904) and an output length classification (906) for each of the one or more discrete workloads (104).
Clause 16. The system of clause 15, wherein the workload scheduler (212) uses a weighted round-robin scheduling algorithm (214) to allocate each of the one or more discrete workloads (104) to the one or more processor clusters (106) based on the one or more discrete workload characteristics (902) comprising the input length classification (904) and the output length classification (906) for each of the one or more discrete workloads (104).
Clause 17. A system (100) for routing discrete workloads (104) to processor clusters (106) co-located with distinct variable-power sources (108) comprising: one or more processors (502); memory (1406) coupled to the one or more processors (502); a means for long-term planning (202) configured to generate a first allocation plan (222) based on one or more workload arrival patterns (206) and long-term predicted power availability (204) on a first, longer timescale from one or more distinct variable-power sources (108); a means for short-term planning (208) configured to generate a second allocation plan (604) based on the first allocation plan (222), the one or more workload arrival patterns (206), and short-term predicted power availability (602) on a second, shorter timescale from the one or more distinct variable-power sources (108); and a means for workload scheduling (210) configured to allocate the one or more discrete workloads (104) to one or more processor clusters (106) co-located with distinct variable-power sources (108) based on the second allocation plan (604).
Clause 18. Computer-readable storage media comprising instructions stored in a memory (1404) that when executed by a processor (502) cause a computing device (1400) to perform acts comprising: generating a first allocation plan (222) based on one or more workload arrival patterns (206) and long-term predicted power availability (204) on a first, longer timescale from one or more distinct variable-power sources (108); generating a second allocation plan (604) based on the first allocation plan (222), the one or more workload arrival patterns (206), and short-term predicted power availability (602) on a second, shorter timescale from the one or more distinct variable-power sources (108); and allocating one or more discrete workloads (104) to one or more processor clusters (106) co-located with one of the distinct variable-power sources (108) based on the second allocation plan (604).
Clause 19. The computer-readable storage media of clause 18, wherein the first allocation plan (222) comprises a tensor parallelism metric (224) and a processor frequency metric (226) that is based on the first, longer timescale.
Clause 20. The computer-readable storage media of clause 19, wherein the second allocation plan (604) comprises an other processor frequency metric (606) based on the second, shorter timescale.
Clause 21. The computer-readable storage media of clause 20, wherein the instructions cause the computing device (1400) to perform acts further comprising configuring individual processors (502) in the one or more processor clusters (106) based on the tensor parallelism metric (224) and a processor frequency metric (226) of the first allocation plan (222) and the other processor frequency metric (606) of the second allocation plan (604).
Clause 22. The computer-readable storage media of any one of clauses 18 to 21, wherein the one or more workload arrival patterns (206) comprise a predicted number of discrete workloads (104) and a discrete workload characteristic (902) prediction for each of the predicted number of discrete workloads (104) comprising an input length classification (904) and an output length classification (906).
Clause 23. The computer-readable storage media of any one of clauses 18 to 22, wherein the instructions cause the computing device (1400) to perform acts further comprising determining one or more discrete workload characteristics (902) comprising an input length classification (904) and an output length classification (906) for each of the one or more discrete workloads (904).

### CONCLUSION

While certain example embodiments have been described, including the best mode known to the inventors for carrying out the invention, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. Skilled artisans will know how to employ such variations as appropriate, and the embodiments disclosed herein may be practiced otherwise than specifically described. The accompanying claims and their equivalents are intended to cover such forms or modifications as would fall within the scope and spirit of certain of the inventions disclosed herein.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context. The terms “portion,” “part,” or similar referents are to be construed as meaning at least a portion or part of the whole including up to the entire noun referenced.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different models).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for routing discrete workloads to processor clusters co-located with distinct variable-power sources comprising:
generating a first allocation plan based on one or more workload arrival patterns and long-term predicted power availability on a first, longer timescale from one or more distinct variable-power sources;
generating a second allocation plan based on the first allocation plan, the one or more workload arrival patterns, and short-term predicted power availability on a second, shorter timescale from the one or more distinct variable-power sources; and
allocating the one or more discrete workloads to one or more processor clusters co-located with one of the distinct variable-power sources based on the second allocation plan.

2. The method of claim 1, wherein the first allocation plan comprises a tensor parallelism metric and a processor frequency metric that is based on the first, longer timescale.

3. The method of claim 2, wherein the second allocation plan comprises an other processor frequency metric based on the second, shorter timescale.

4. The method of claim 3, further comprising:
configuring individual processors in the one or more processor clusters based on the tensor parallelism metric and the processor frequency metric of the first allocation plan; and
updating the configuration of the individual processors based on the other processor frequency metric of the second allocation plan.

5. The method of claim 1, wherein the one or more workload arrival patterns comprise a predicted number of discrete workloads and a discrete workload characteristic prediction for each of the predicted number of discrete workloads comprising an input length classification and an output length classification.

6. The method of claim 1, wherein the first allocation plan is generated using a first integer linear program and the second allocation plan is generated using a second integer linear program.

7. The method of claim 1, wherein each of the one or more discrete workloads comprises one or more AI inference requests.

8. A system for routing discrete workloads to processor clusters co-located with distinct variable-power sources comprising:
one or more processors;
memory coupled to the one or more processors;
a long-term planner configured to generate a first allocation plan based on one or more workload arrival patterns and long-term predicted power availability on a first, longer timescale from one or more distinct variable-power sources;
a short-term planner configured to generate a second allocation plan based on the first allocation plan, the one or more workload arrival patterns, and short-term predicted power availability on a second, shorter timescale from the one or more distinct variable-power sources; and
a workload scheduler configured to allocate the one or more discrete workloads to one or more processor clusters co-located with distinct variable-power sources based on the second allocation plan.

9. The system of claim 8, wherein the first allocation plan comprises a tensor parallelism metric and a processor frequency metric that is based on the first, longer timescale.

10. The system of claim 9, wherein the second allocation plan comprises an other processor frequency metric based on the second, shorter timescale.

11. The system of claim 10, further comprising a configurator configured to configure individual processors in the one or more processor clusters based on the tensor parallelism metric and the processor frequency metric of the first allocation plan and the other processor frequency metric of the second allocation plan.

12. The system of claim 8, wherein the one or more workload arrival patterns comprise a predicted number of discrete workloads and a discrete workload characteristic prediction for each of the predicted number of discrete workloads comprising an input length classification and an output length classification.

13. The system of claim 8, wherein the workload scheduler comprises a discrete workload class predictor configured to determine one or more discrete workload characteristics comprising an input length classification and an output length classification for each of the one or more discrete workloads.

14. The system of claim 13, wherein the workload scheduler uses a weighted round-robin scheduling algorithm to allocate each of the one or more discrete workloads to the one or more processor clusters based on the one or more discrete workload characteristics comprising the input length classification and the output length classification for each of the one or more discrete workloads.

15. Computer-readable storage media comprising instructions stored in a memory that when executed by a processor cause a computing device to perform acts comprising:
generating a first allocation plan based on one or more workload arrival patterns and long-term predicted power availability on a first, longer timescale from one or more distinct variable-power sources;
generating a second allocation plan based on the first allocation plan, the one or more workload arrival patterns, and short-term predicted power availability on a second, shorter timescale from the one or more distinct variable-power sources; and
allocating one or more discrete workloads to one or more processor clusters co-located with one of the distinct variable-power sources based on the second allocation plan.

16. The computer-readable storage media of claim 15, wherein the first allocation plan comprises a tensor parallelism metric and a processor frequency metric that is based on the first, longer timescale.

17. The computer-readable storage media of claim 16, wherein the second allocation plan comprises an other processor frequency metric based on the second, shorter timescale.

18. The computer-readable storage media of claim 17, wherein the instructions cause the computing device to perform acts further comprising configuring individual processors in the one or more processor clusters based on the tensor parallelism metric and a processor frequency metric of the first allocation plan and the other processor frequency metric of the second allocation plan.

19. The computer-readable storage media of claim 15, wherein the one or more workload arrival patterns comprise a predicted number of discrete workloads and a discrete workload characteristic prediction for each of the predicted number of discrete workloads comprising an input length classification and an output length classification.

20. The computer-readable storage media of claim 15, wherein the instructions cause the computing device to perform acts further comprising determining one or more discrete workload characteristics comprising an input length classification and an output length classification for each of the one or more discrete workloads.
